(19) United States
(12) Patent Application Publication
(10) Pub. No.: US 2003/0107644 A1
(43) Pub. Date: Jun. 12, 2003

(54) Movie camera and photographing method for obtaining three-dimenstional image

(76) Inventor: Boo-Jin Choi, Seoul (KR)

Correspondence Address: BAKER & BOTTS, 30 ROCKEFELLER PLAZA, NEW YORK, NY, 10112

(21) Appl. No.: 10/275,632

(22) PCT Filed: May 8, 2001
(86) PCT No.: PCT/KR01/00737

(30) Foreign Application Priority Data
May 9, 2000 (FR) 2000-24773
Mar. 5, 2001 (KR) 2001/11205

(51) Int. Cl. H04N 13/02; H04N 15/00

(52) U.S. Cl. 348/49; 382/154

(57) ABSTRACT

The present invention relates to a movie camera and a method for photographing an object in three-dimensional which makes it possible to photograph for 3-D while taking picture so that image on display can be shown in three-dimensional, but with no help of special glasses or complex optical instruments. An movie camera for stereoscopically taking a photograph of an object in three dimensional comprises a camera body provided with an image record units for obtaining the photograph; a lens assemble installed into the camera body, capable of being attached to and separated from the camera body, wherein the lens assemble includes a plurality of lens for imaging an object on the image record unit of the camera body, a first input means for providing a left eye image of the object to the image record unit; and a second input means for providing a fight eye image of the object to the image record unit.

### DESCRIPTION

### TECHNICAL FIELD

The present invention relates to a method and an apparatus for stereoscopically taking a photograph of an object; and, more particularly, to a method and an apparatus for photographing an object in three-dimensional by using a binocular disparity.

### BACKGROUND ART

It's been tried to display familiar sceneries around our daily life or the beauty of nature in lively cubic image, not in plane two-dimensional figures, thus accelerating the studies of 3-D (three-dimensional) cubic vision and the principle of 3-D display.

Basically, each left and right eyes of a human being receives a bit different images from each other, but the two different images are processed automatically and felt in the brain by repeated learning since the birth. In case of two-dimensional contents, however, both eyes see one identical image, feeling uncomfortable differently from seeing cubical objects, but getting to acknowledge it as a plane naturally from repeated experience.

There are factors that make people acknowledge three-dimensional space. Largely, they can be classified into physiological ones and empirical ones. Physiological factors include crystalline lens accommodation, convergence, binocular parallax and so forth, while empirical ones include monocular movement disparity, linear perspective, areal perspective, light shade and overlapping, etc.

Factors above get together and make a human being acknowledge three-dimension. Three-dimensional image display apparatuses being developed recently realize three-dimensional image by making use of binocular parallax, one of factors that make us acknowledge three-dimension.

The 3-D image that makes use of binocular parallax is a method in which figures for left-eye and ones for right-eye are photographed respectively from different angles with at least two cameras for obtaining 3-D images and then the left and the right eye images get separated and shown to viewers.

Methods for achieving 3-D image are represented in two types: one with spectacles on and the other without spectacles.

A type wearing glasses includes methods of anaglyph, of density difference and of polarized light filter. Also, there is a method utilizing LCD (liquid crystal display) spectacles or HMD (head mount display) that opens or shuts pictures for left or right eyes of the spectacles with an LCD shutter in turn at the same time, converting pictures into images for each left and right eye, obtaining three-dimensional image.

To briefly describe the principle of getting 3-D image in a method using spectacles, it requires two image projectors, each of which projects images for the left eye or for the right eye respectively onto a screen. That is, images thrown from the two projectors are projected crossed to each other and the viewers watch the images with polarized light glasses on.

A 3-D image projector of the above method have advantages of wide view coverage and of being-able to enjoy 3-D image just with wearing a simple apparatus of polarized light spectacles. However, using two expensive projectors, it has a shortcoming of high cost.

Thus following is a 3-D image display apparatus of Korean Patent Publication No. 2000-0039515 issued on July 5, 2000, where a method is suggested that makes it possible to enjoy 3-D image with wide view coverage utilizing just one display device as an embodiment for solving the problem in three-dimensional image. It also, however, have a problem of having to wear glasses, which makes viewers feel inconvenience, thus limiting popular use by the public.

Meanwhile, as for ways of enjoying three-dimensional image without wearing glasses, there are parallax bayer method that shows different images for each left and right eye by using a cover plate over slit, lenticular lens method where display light is divided into right and left through lenticular lens or prismatic lens, and a method of providing 3-D images by separating figures into ones for right eye and ones for left eye, respectively, with use of complex optical instruments.

FIG. 1 shows an example of the above lenticular lens method where a left picture and a right picture LP RP on display come into the screen of lenticular lens 1. Between the two pictures, the left one LP gets to the left eye of a viewer and the right one to the right eye of the viewer, and then the two pictures are combined in brain, being perceived as one picture therein.

However, providing 3-D image through the lenticular lens, this non-spectacle method above has a disadvantage of fixing viewpoint thus restricting the place for the viewer's eyes. So, when a viewer moves to another places or moves his head, he gets to meet non-cubical picture, thus failing to see 3-D image practically.

### DISCLOSURE OF INVENTION

It is, therefore, an object of the present invention to provide a method and an apparatus for obtaining a stereoscopic image which makes it possible to photograph for 3-D while taking picture so that image on display can be shown in three-dimensional, but with no help of special glasses or complex optical instruments.

It is another object of the present invention to make the public enjoy 3-D on any display media free from the restriction of place.

In accordance with one aspect of the present invention, there is provided a camera body provided with an image record units for obtaining photographs; a lens assemble installed into the camera body, capable of being attached to and separated from the camera body, wherein the lens assemble includes a plurality of lens for imaging an object on the image record unit of the camera body; a first input means for providing a left eye image of the object to the image record unit; and a second input means for providing a right eye image of the object to the image record unit.

In accordance with another aspect of the present invention, there is provided a first/second input device including a first/second eye image input means, among which the first eye image input means includes a first guide means for guiding the image from the object; and a first reflecting means for transmitting the image to the image record unit through the lens assemble, while the second eye image input means includes a second guide means for guiding the image from the object; and a second reflecting means for transmitting the image to the image record unit through the lens assemble.

In accordance with another aspect of the present invention, there is provided a strobe of the camera being disk-shaped with a plurality of opened sectors formed at a predetermined interval.

In accordance with another aspect of the present invention, there is provided a strobe including a plurality of opened sectors formed at a predetermined interval and is formed with two disks engaged in to each other and move together.

In accordance with another aspect of the present invention, there is provided a strobe rotating at a speed (rotation/sec) of more than 50/n, n being the number of an opened sector).

In accordance with another aspect of the present invention, there is provided a first/second input devices including an first/second input means, one end of which is installed confronting the main lens of the lens and the other end of which is divided into two branches of input units, each for left and right, respectively and get angled with a reflector that reflects the object figure at places where the branches are angled; and a strobe which alternately opens and shuts the left/right input units of the first/second input means according to signal from an electronic circuit.

In accordance with another aspect of the present invention, there is provided a strobe conducting the open and shut movement more than 50 times a second at each input unit.

In accordance with another aspect of the present invention, there is provided a method for photographing an object in three-dimensional comprising the steps of providing a left/right input unit, which is formed in the same ratio of left eye image and right eye image of a human being, separating an object figure into the left eye image and the right eye image, respectively and providing them alternately; providing the each left and the right eye images to the lens assemble equipped with a plurality of lens for setting a focus; recording each left and the right eye image from the lens assemble to the image record unit of the camera body, wherein predetermined constituents for photographing picture are incorporated.

In accordance with another aspect of the present invention, there is provided a left eye image and right-eye image being shown more than 50 times per second, respectively.

In accordance with another aspect of the present invention, there is provided a left and the right eye images recorded in the image record unit of the camera body being separated into left eye images and right eye images and recorded alternately and consecutively.

In accordance with another aspect of the present invention, there is provided a left and the right eye images recorded in the image record unit of the camera body being recorded more than a pair of left and the right eye images.

In accordance with another aspect of the present invention, there is provided a method for photographing an object in three dimensional for animation comprising the steps of recording s and right eye images of each scene to each frame repeatedly more than three times; playing the recorded figures; and re-photographing the played images with another camera.

In accordance with another aspect of the present invention, there is provided 100 frames of image being played per second in the step of playing image.

### BRIEF DESCRIPTION OF DRAWINGS

Other objects and aspects of the invention will become apparent from the following description of the embodiments with reference to the accompanying drawings, in which:

FIG. 1 is a descriptive figure illustrating Lenticular method that allows to enjoy images in three-dimensional without wearing any spectacles;

FIGS. 2A to 2C are diagrams showing the process of a first experiment to help understand the principle of an embodiment of the present invention;

FIGS. 3A and 3B are diagrams showing the process of a second experiment to help understand the principle of an embodiment of the present invention;

FIG. 4 is a schematic illustrating an embodiment of a movie camera for obtaining 3-D image in accordance with the present invention;

FIG. 5 is a plane figure illustrating the inside of an embodiment of a movie camera for obtaining 3-D image in accordance with the present invention;

FIG. 6 is a side-view showing the inside of an embodiment of a movie camera for obtaining 3-D image in accordance with the present invention;

FIG. 7 is a schematic of another embodiment of a movie camera for obtaining 3-D image in accordance with the present invention;

FIG. 8 is a diagram for describing the movement of an opening and shutting unit in accordance with an embodiment of the present invention;

FIG. 9 is a film disposition of an embodiment photographed in accordance with the present invention.

FIG. 10A is a film disposition of another embodiment of the present invention; and

FIG. 10B is a diagram comparing the image of FIG. 10A with existing image film for describing the figure recorded on FIG. 10A.

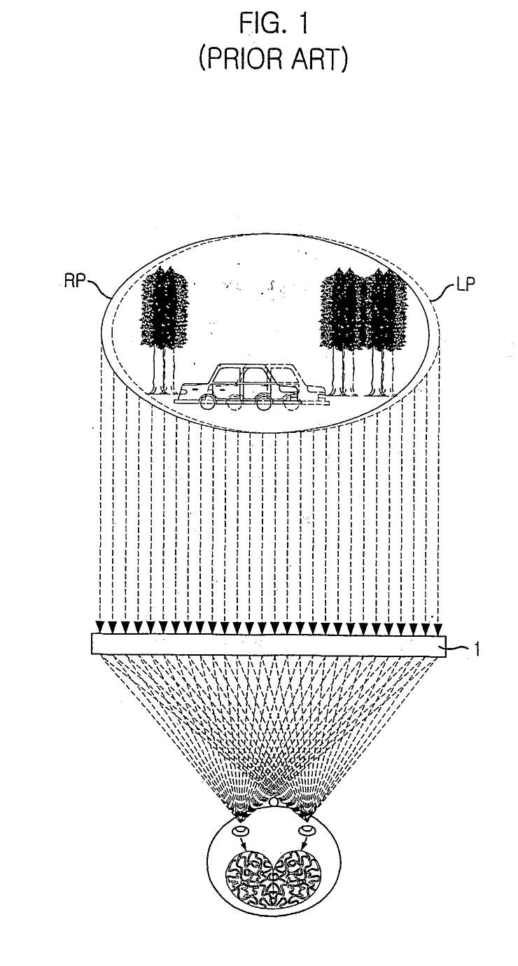

### BEST MODE FOR CARRYING OUT THE INVENTION

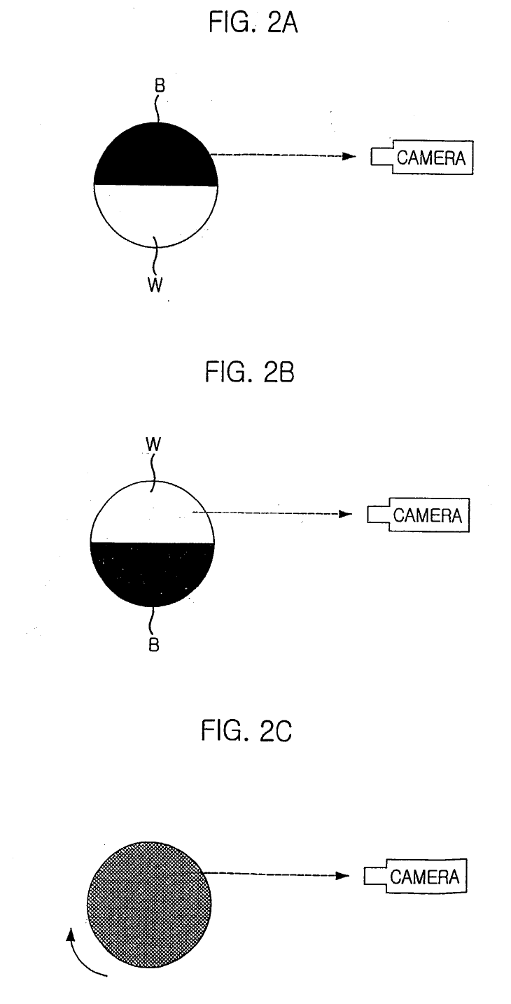

FIGS. 2A to 2C show the process of a first experimental example to help understand the principle of an embodiment of the present invention.

As shown in the figures, in a first experiment, there is a disk plate, half of which is black B and the other half of which is white W, and a camera gets fixed to photograph only half of the disk plate. First, if the black half of the disk plate is turned to the camera and photographed, the camera takes picture of the black half. And then the plate is turned around with white half toward the camera, the camera gets to take picture of the white half. So, when the disk plate is set to rotate more than 100 times a second and then photographed, the color becomes shown neither black nor white but close to gray due to after-image effect.

This is because of the after-image effect, when the disk plate rotates slowly, the brain of a human being perceives each color separately, but when the disk rotates at more than a predetermined speed, the brain do not perceive the two colors as different ones but as one color, gray, as black and white rotate consecutively in an instant.

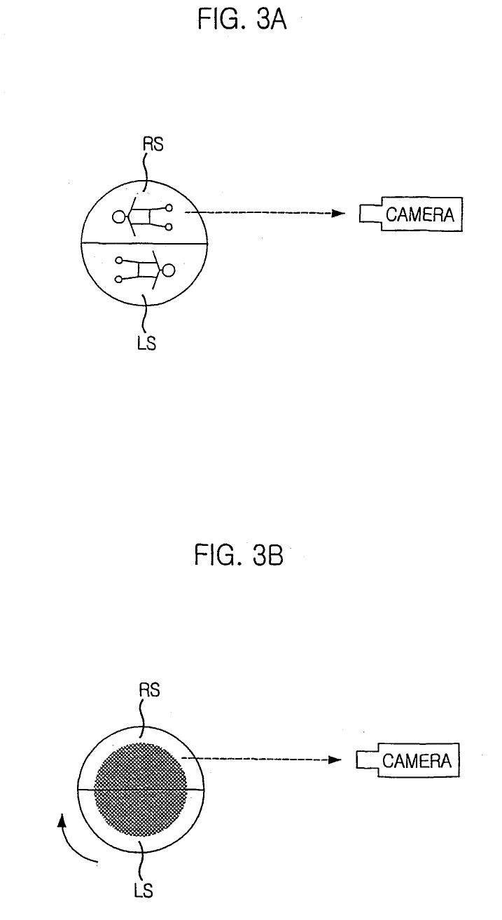

Referring to FIGS. 3A to 3B, a second experimental example is set forth in detail.

First, putting an object picture for the left eye on the half of a disk plate and putting one for the right eye on the other half of the disk plate, you fix a camera toward only a half of the disk.

In this arrangement, if you turn the picture for the right eye toward the camera, a picture for the right eye is taken, and a picture for the left eye is turned around toward the camera, the left eye picture gets to be taken. As FIG. 3C shows, when the disk plate is set to rotate more than 100 times a second and photographed, each picture for the left eye and the right eye strobes consecutively in a very short moment, showing neither the left-eye picture nor right-eye picture but a picture where the focuses of the two pictures get combined into one. Here, you can see the picture in three dimensional because of the after-image effect and the binocular parallax. In this embodiment of an experiment, this procedure of switching a left eye image with a right eye image is adopted from the technique of a motion-picture projector.

Normal cameras do not photograph pictures for left eye and right eye separately. However, the present invention obtains three-dimensional images using the principle of binocular parallax.

Based on the principles and effects shown from above experiments and referring to enclosed figures, embodiments of the present invention is set forth in detail hereinafter.

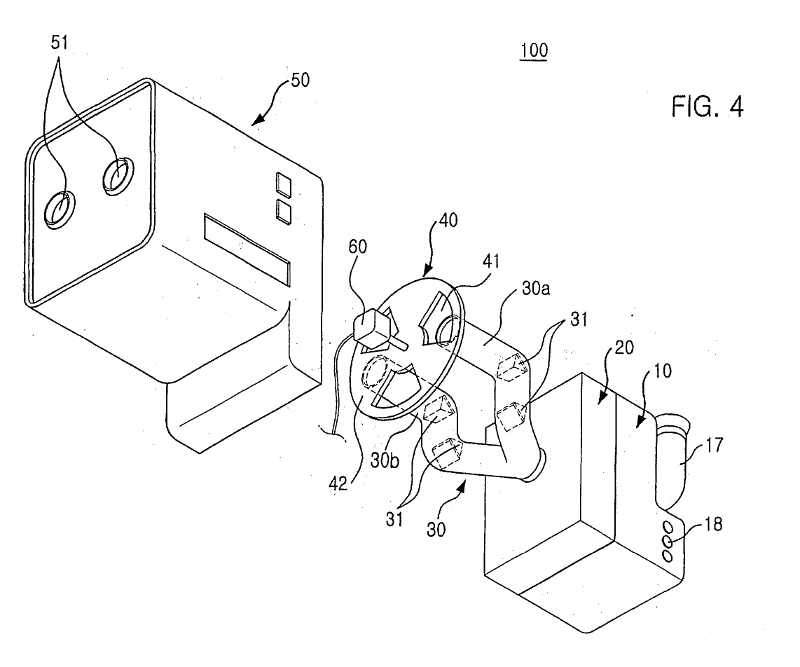

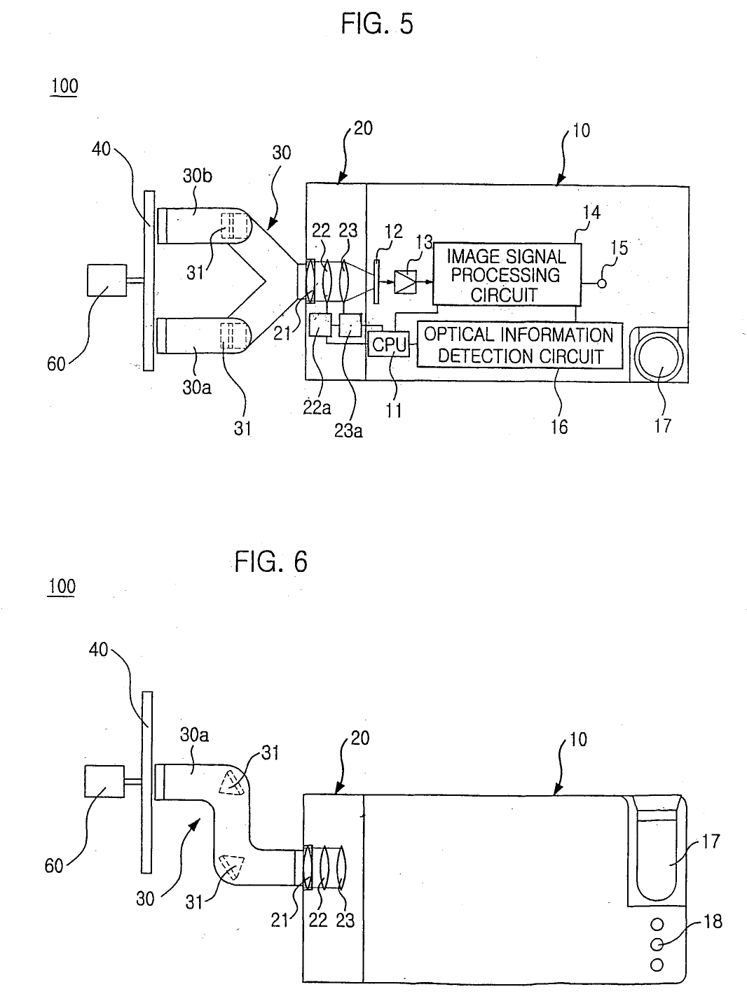

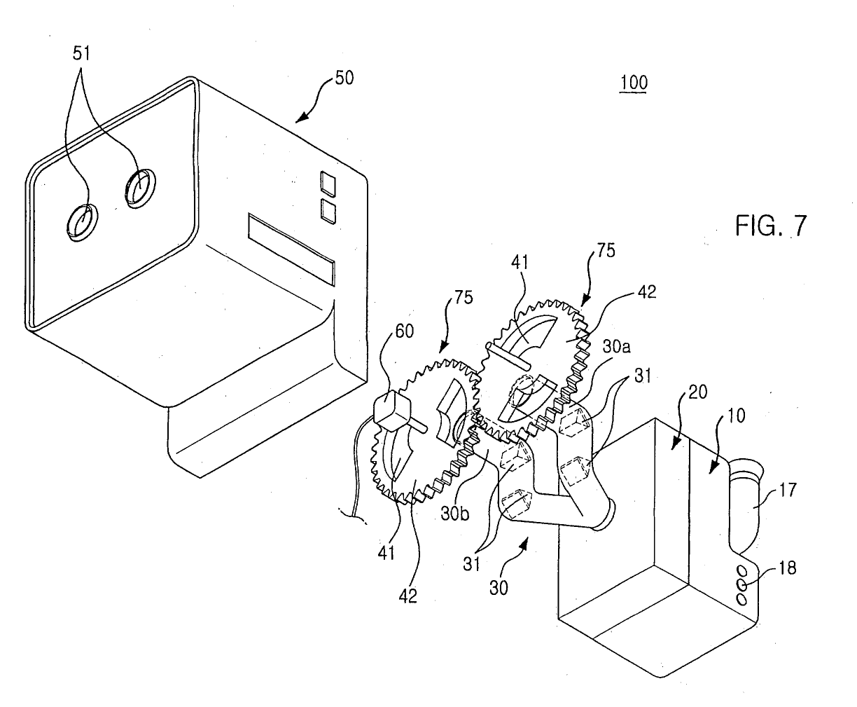

FIG. 4 is a schematic illustrating an embodiment of a movie camera for obtaining three-dimensional image in accordance with the present invention, and FIGS. 5 and 6 are a perspective plane figure and a side-view roughly showing the inside of the camera for obtaining three-dimensional image in accordance with the present invention.

As shown in the figure, a movie camera 100 for obtaining three-dimensional image comprises: a camera body 10 wherein predetermined components for photographing image are incorporated; a lens assemble 20 installed at the fore part of the camera, capable of being attached to or separated from the camera body and including a zoom lens 23 and a focus lens 22 installed movably by a main lens 21 and each motor; an first/second eye image input means 30, one end of which is installed confronting the main lens 21 of the lens assemble 20 and the other end of which is divided into two branches of input units 30A, 30B, each for left and right, respectively and each branch get angled; a strobe 40 installed rotatably at the fore part of the other end of the input means 30, shutting and opening alternately the left and right input units 30A, 30B in order to provide the object image that goes into the left and right input units 30A, 30B through the figure input means 30 into left and right eye images, left eye image and right eye image, to an image record unit (not shown in figures) of the camera body 10, and powered by a motor 60 that is motivated by signals from the CPU 11 of the body 10; and a camera cover 50 wherein two apertures are formed confronting the input units for left and right eyes 30A, 30B and the constituents mentioned above are accommodated.

The usual constituents of the camera body 10 include a solid photograph figure element 12 where the figure of an object which came in through the lens assemble 20 is formed; a video amp 13 which receives the photograph figure signal outputted from the solid photograph figure element 12; an image signal processing circuit 14 which converts the photograph figure signal from the video amp 13 into a predetermined image signal; an output terminal 15 which sends the image signal from the image signal processing circuit 14 to an image record unit (not shown in figures) for recording; an optical information detection circuit 16 which detects image signal information from the image signal processing circuit 14; a central processing unit (CPU) 11 which is formed with a microcomputer, motivating a focus lens 22 and a zoom lens 23 of the lens assemble 20 by signals from the image signal processing circuit 14 and optical information detection circuit 16.

Meanwhile, when an object figure coming in through the left/right input units 30A 30B of the first/second input means 30 is recorded in the image record unit through the lens assemble 20 by one reflector, the recorded image is opposite to the original figure of an object. Thus, the reason to angle the input means 30 is to provide the identical figure with the original one by reflecting the figure in opposition once again.

Also, the left/right input unit 30A 30B of the first/second eye image input means 30 is formed at the same distance ratio as the binocular parallax of a human being.

The strobe 40 is provided with an opened sector 41 and a shutting sector 42 on a disk for the images for each eye to be separated and go into the camera through the first/second eye image input means 30. Here, the opened sector is formed in plurality at a predetermined distance.

When the left input unit 30A of the first/second eye image input means 30 gets open by the opened sector 41 of the strobe 40 with the right input unit 30B closed by the shutting sector 42, a left eye image is provided. In the same way, when the strobe 40 makes a predetermined rotation (FIG. 2 is making a sixth of a rotation), the right input unit 30B gets open by the opened sector 41 of the strobe 40 with the left input unit 30A closed by the shutting unit 42, thus providing a right eye image.

Here, unless the strobe 40 makes this shutting movement, an object figure goes into a first/second eye image input means 30 simultaneously through left/right input units 30A 30B, forming figures for both eyes at the image record unit of the frame at the same time, thereby making an overlapped image.

The strobe 40 in FIG. 4 is powered with a motor 60installed separately from the motor (not shown in figures) in a camera body 10 that transfers the image record unit, but it's possible to make the strobe powered with the motor that transfers the image record unit.

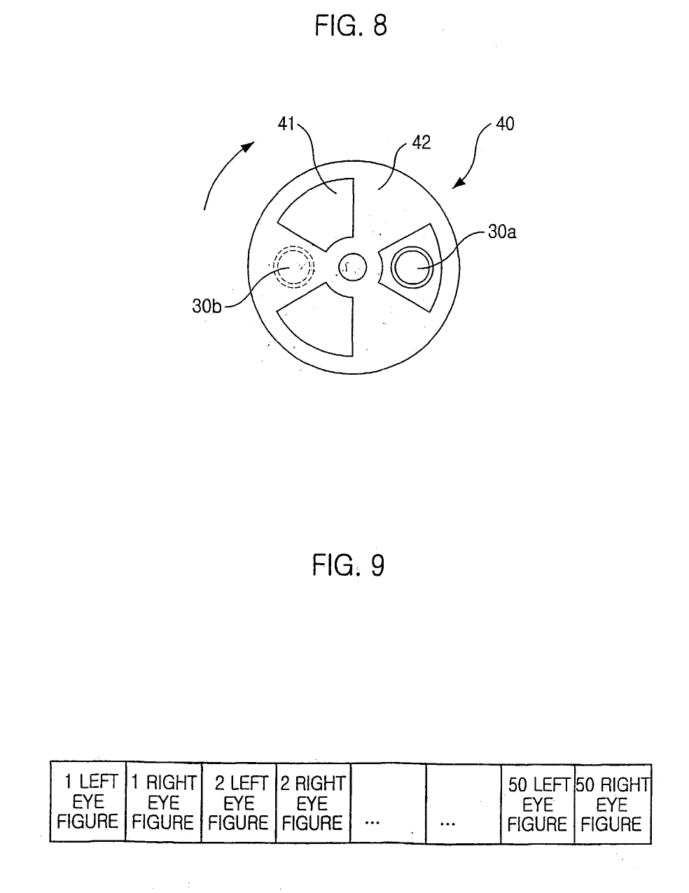

In the mean time, FIG. 7 is a schematic of an embodiment of the camera for obtaining 3-D image in accordance with the present invention. As shown in the figure, a strobe is provided with two disk plates installed eccentrically in opposition to each other with a central axis of left/right input units 30A, 30B of a first/second eye image input means 30 at center. It's also possible to make a strobe 75 wherein the two disk plates are engaged in to each other and move together. Here, when the strobe rotates engaged in to each other, the left/right input units 30A, 30B of the first/second eye image input means 30 are open or closed alternately by an opening 41 and shutting sector 42 so that each left eye image and right eye image can go to the camera alternately and consecutively, whereby providing each left and right figures to the image record unit.

The strobe 40, 75 is providing an organization where the left/right input units 30A, 30B are open and closed by the rotation of a motor. However, the strobe can also be formed with the known existing art that opens or shuts light from the left/right input units 30A, 30B following electronic circuit signal, for example, a strobe including a shutter that accords with electric signal.

It's possible to attach the first/second eye image input means 30 of the input device and the strobe 40 to the camera body generally used for photographing motion picture.

The undescribed mark 17 is a common viewfinder that makes the cameraman photograph while seeing an object, and the mark 18 represents function buttons of the camera.

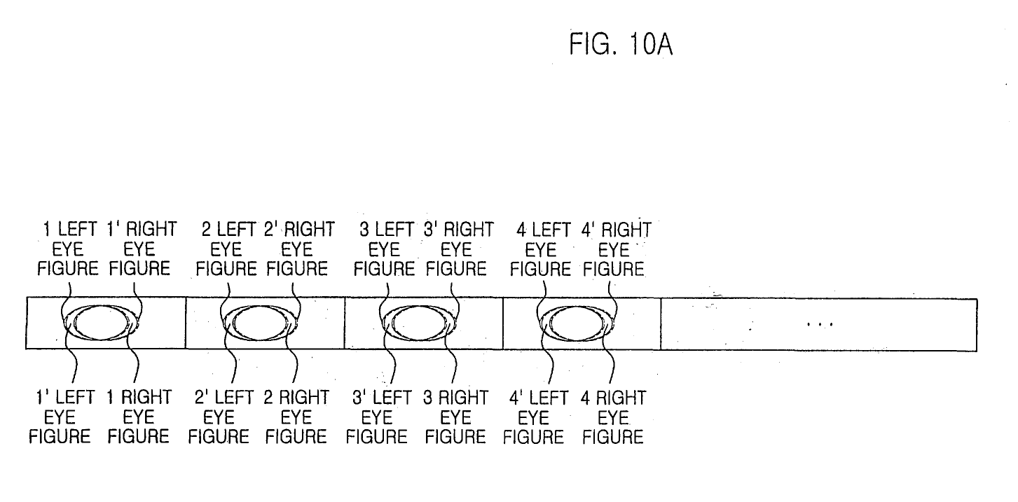

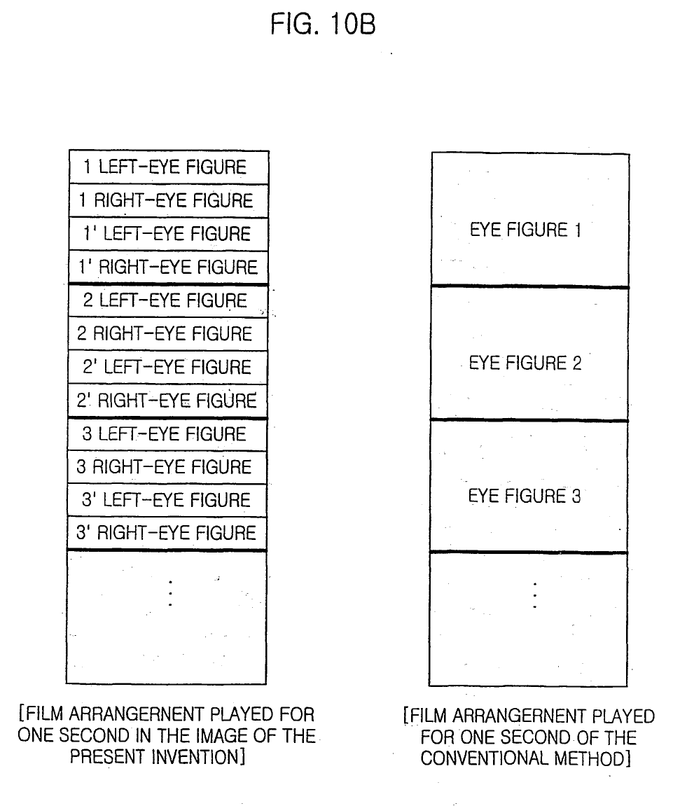

Referring to FIGS. 8 and 9, in accordance with the present invention, the movement of camera for obtaining the three-dimensional image is set forth hereinafter.

FIG. 8 is a diagram for describing the opening and shutting movement of a strobe in accordance with an embodiment of the present invention, and FIG. 9 is one illustrating the arrangement of a film photographed in accordance with an embodiment of the present invention.

First, photographing order transmitted following signals from the CPU 11 of a camera body 10, a film motor (not shown in figures) and a strobe motor 60 start working.

If the strobe 40 rotates at a predetermined speed by the strobe motor 50, left and the right eye images of an object figure are provided-continuously to the image record unit through the lens assemble 20 and the left/right input unit 30A, 30B of the first/second image input means 30 by the alternate movement of the opening 41 and shutting sectors 42.

Here, in order to form one single three-dimensional image in accordance with the binocular parallax when the left and the right eye images are shown so as to form more than 50 cuts per second, the rotation speed of the strobe 40 has a numerical formula as following:

2n×r/s=100 [Formula]

In this formula, 100 is the sum figure of the number of cuts, 50, each left and right eye pictures are taking for one second. 2 is the number of input units of the first/second eye image input means while n is the number of the opened sector 41 of the strobe 40, and r/s represents the rotation speed per second of the strobe.

Therefore, the rotation speed of the strobe 40 can be represented as following.

r/s=50/n (n is plural) [Formula]

If the strobe 40 rotates at a speed above, the object figure goes through the entrance of the left/right input units 30A, 30B of the first/second input means 30 by the opening 41 and shutting sectors 42 formed on the strobe 40, thus figures are separated into ones for left eye and for right eye and get recorded at the image record unit in a way of a first left eye image, a first right eye image, a second left eye image, a second right eye image and so on, as shown in FIG. 9.

Here, if the separation of left eye image and right eye image is done not by the rotation of the strobe 40 powered by a motor, but by a switching means alternately open and shut by signal from an electronic circuit, the strobes at each input units receive electric signal to make 50 times of an open and shut movement per second.

During the movement of the strobe, if you connect the camera to a display or play the images with the camera viewfinder 17, you can get 3-D images both left and right eye images are combined together by the after-image effect and binocular parallax. And then when played in a conventional method, that is, reproducing 24 frames per 35 second, each figure gets shown alternately and a bit different images look overlapped on display, but when playing 100 frames a second, a single combined 3-D image is obtained on display.

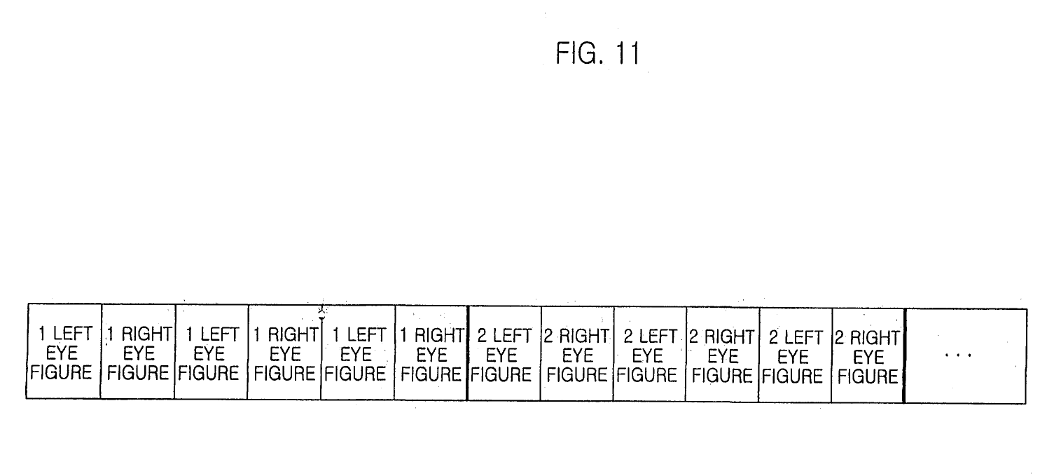

FIG. 10A is a diagram showing a film arrangement of another embodiment of the present invention, and FIG. 10B is a diagram for describing the figure photographed in FIG. 10A, compared with existing image films. The film arrangement of FIG. 9 in accordance with an embodiment sets up the strobe to rotate at a predetermined speed in the same ratio as the transfer speed of a film and form either left eye images or right eye images. On the other hand, the film arrangement of FIG. 10A is set up to form a plurality of left and right figures (two pairs of left and the right eye images in the figure) simultaneously.

In other words, the object figures are provided to the image record unit in a plurality of left and right eye images overlapped.

For example, as shown in FIG. 10A, a first left eye image is provided to a frame through the left input unit 30A opened by the rotation of the strobe 40, followed by a first right eye image provided to the frame through the right input unit 30B opened thereafter. And then the left input unit 30A gets opened again to the frame, providing a first prime (1′) left eye image, once again followed by the right input unit 30B opened thus providing a first prime (1′) right eye image. This way, a plurality of left and right eye images is provided in one frame, and then is provided consecutively to another frames in a series of movement described above. Here, the image difference between the first left eye image and the first prime left eye image is exceedingly minute as the strobe rotates very fast compared with the film transfer speed, and the same is true for the difference between the first right eye image and the first prime right eye image.

In other words, as shown in FIG. 10B as an example, while the conventional skill records a scene in one frame among 24 frames played for one second, the present invention records a figure of a scene as more than two pairs of left and the right eye images in one frame. Therefore, when a film of the present invention is played in a conventional image player, more than 96 left and right eye images are shown per second, thereby yielding 3-D images.

FIG. 11 shows how to obtain three-dimensional image in animation.

FIG. 11 is a diagram illustrating a film arrangement for 3-D image in animation. As shown in the figure, by recording each left eye image and each right eye image for one scene more than three times, and for the next scenes, recording again the each left eye image and right eye image more than three times, you record left eye image and right eye image repeatedly more than three times.

When you play the film recorded in the above method, left and right eye images are shown repeatedly. If they are played at a speed that makes them shown combined, preferably three times as fast as the conventional speed, three-dimensional images are shown on display. If you re-photograph the 3-D image with other camera and play it on other existing display media at a predetermined speed, 3-D image can be obtained, too.

As described above, a movie camera and a photograph method for obtaining 3-D image in accordance with the present invention makes it possible to photograph in three-dimensional easily while taking picture so that image on display can be shown in three-dimensional, but with no help of special glasses or complex optical instruments.

Also, the present invention can make the public enjoy 3-D on any display media free from the restriction of place.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. An apparatus for taking a photograph in three-dimensional, comprising:
a camera body provided with an image record unit for obtaining the photograph;
a lens assemble installed into the camera body, capable of being attached to and separated from the camera body, wherein the lens assemble includes a plurality of lens for imaging an object on the image record unit of the camera body;
a first input means for providing a left eye image of the object to the image record unit; and
a second input means for providing a right eye image of the object to the image record unit.

2. The apparatus of claim 1, further comprising a strobe for alternately switching the first and the second input means.

3. The apparatus of claim 1, wherein the first input means includes:
a first guide means for guiding the image from the object; and
a first reflecting means for transmitting the image to the image record unit through the lens assemble.

4. The apparatus of claim 3, wherein the first reflecting means further includes a pair of prisms.

5. The apparatus of claim 3, wherein the second input means includes:
a second guide means for guiding the image from the object; and
a second reflecting means for transmitting the image to the image record unit through the lens assemble.

6. The apparatus of claim 5, wherein the second reflecting means further includes a pair of prisms.

7. The apparatus of claim 2, wherein the strobe is in a form of a disk with a plurality of opened sectors, each of which is formed at a predetermined interval thereon.

8. The apparatus of claim 2, wherein the strobe includes a plurality of opened sectors formed at the same interval and is formed with two disks engaged in to each other and move together.

9. The apparatus of claim 7, wherein the strobe rotates at a speed (rotation/sec) of more than 50/n, n being the number of opened sectors.

10. The apparatus of claim 1, wherein the first/second eye image input device includes:
a first input means for providing a left eye image of the object to the image record unit;
a second input means for providing a right eye image of the object to the image record unit; and
a strobe for alternately switching the two branches according to a signal from an electronic circuit.

11. The apparatus of claim 10, wherein the strobe flashes on and off more than 50 times a second at each input unit.

12. The apparatus of claim 1, wherein the image recorded on the image record unit is provided as a left eye image or a right eye image separately.

13. The apparatus of claim 1, wherein the image recorded on the image record unit is provided in more than pair of left and right eye image to one frame.

14. A method for photographing an object in three-dimensional, comprising the steps of:
a) taking a left image and a right eye image alternately;
b) providing the left and the right eye images to a lens assemble;
c) recording the left and the right eye image to an image record unit with overlapping each other.

15. The method of claim 10, further comprising the step of alternately displaying the left eye images and right eye images more than 50 times per second.

16. The method of claim 10, wherein the left and the right eye images recorded in the image record unit are separated into left eye images and right eye images and recorded alternately and consecutively.

17. The method of claim 10, wherein the left and the right eye images recorded in the image record unit of the camera body are recorded more than a pair of left and the right eye images.

18. A method for photographing an object in three-dimensional for animation, comprising the steps of:
a) recording left eye images and right eye images of each scene to each frame repeatedly;
b) recording the pictures played at a high speed twice as fast as a normal speed, when the recorded image is played; and
c) re-photographing the played images with another camera.

19. The method of claim 8, wherein 100 frames of image are shown every second.

20. An adapter for use with a three dimensional camera, comprising:
a lens assemble installed into the three dimensional camera, capable of being attached to and separated from the three dimensional camera, wherein the lens assemble includes a plurality of lens for imaging an object on an image record unit which is incorporated into the three dimensional camera;
a first input means for providing a left eye view of the object to the image record unit; and
a second input means for providing a right eye view of the object to the image record unit.
